(19) United States
(12) Patent Application Publication
(10) Pub. No.: US 2026/0180154 A1
(43) Pub. Date: Jun. 25, 2026

(54) TERMINAL ANTENNA AND ELECTRONIC DEVICE

(71) Applicant: HONOR DEVICE CO., LTD., Shenzhen (CN)

(72) Inventors: Shaofei Xue, Shenzhen (CN); Hui Yu, Shenzhen (CN); Yong Wang, Shenzhen (CN); Zengfan Chen, Shenzhen (CN)

(21) Appl. No.: 19/542,018

(22) Filed: Feb. 17, 2026

Related U.S. Application Data
(63) Continuation of application No. PCT/CN2024/081507, filed on Mar. 13, 2024.

(30) Foreign Application Priority Data
Aug. 30, 2023 (CN) 202311104950.4

(51) Int. Cl. H01Q 1/22; H01Q 5/30

(52) U.S. Cl. CPC H01Q 1/22; H01Q 5/30

(57) ABSTRACT

Embodiments of this application disclose a terminal antenna and an electronic device, and relate to the field of antenna technologies. The solution includes: a first radiation part and a second radiation part. An operating frequency band of the first radiation part includes a first frequency band and a second frequency band. The second radiation part includes at least one of the following: at least one first radiation unit and at least one second radiation unit, where a ground point is disposed on the first radiation unit; a length of the first radiation unit is less than a quarter of a wavelength of the second frequency band; the second radiation unit is a suspended radiator; and a length of the second radiation unit is less than a half of the wavelength of the second frequency band.

### CROSS-REFERENCE TO RELATED APPLICATIONS

This application is a continuation of International Application PCT/CN2024/081507, filed on Mar. 13, 2024, which claims priority to Chinese Patent Application No. 202311104950.4, filed on Aug. 30, 2023, both of which are incorporated herein by reference in their entireties.

### TECHNICAL FIELD

This application relates to the field of antenna technologies, and in particular, to a terminal antenna and an electronic device.

### BACKGROUND

A wireless communication function is achieved in an electronic device through a disposed antenna. For a foldable electronic device, an example in which a main screen antenna is disposed on a side of a main screen is used. In a closed state, a secondary screen is interlocked with the main screen. Proximity of a metal material on the secondary screen to the main screen antenna significantly affects wireless communication quality of the electronic device in the closed state.

### SUMMARY

Embodiments of this application provide a terminal antenna and an electronic device. A metal material on a secondary screen is disposed in a targeted manner, so that the metal material like a metal frame on the secondary screen does not significantly affect normal operation of a main screen antenna in a closed state.

To achieve the foregoing objectives, the following technical solutions are used in embodiments of this application.

According to a first aspect, a terminal antenna is provided. The terminal antenna is disposed in an electronic device, where the electronic device includes a first part and a second part, and the first part is connected to the second part through a folding axis. When the electronic device is in a closed state, the first part and the second part are interlocked with each other, and when the electronic device is in an unfolded state, the first part and the second part are in a same plane. The terminal antenna includes: a first radiation part and a second radiation part. The first radiation part is disposed on the first part. At least one feed point is disposed on the first radiation part, the first radiation part receives a feed signal through the at least one feed point to radiate, and an operating frequency band of the first radiation part includes a first frequency band and a second frequency band. A center frequency of the second frequency band is higher than that of the first frequency band. The second radiation part is disposed on the second part. When the electronic device is in the closed state, a projection of the first radiation part onto the second part at least partially coincides with the second radiation part. The second radiation part includes at least one of the following: at least one first radiation unit and at least one second radiation unit, where a ground point is disposed on the first radiation unit; a length of the first radiation unit is less than a quarter of a wavelength of the second frequency band; the second radiation unit is a suspended radiator; and a length of the second radiation unit is less than a half of the wavelength of the second frequency band.

In this way, the second radiation part on the secondary screen is configured to include the first radiation unit and/or the second radiation unit, so that even in the closed state, a current opposite to that on the first radiation part is not generated on the second radiation part, thereby avoiding degradation of radiation performance of the main screen antenna caused by proximity of the second radiation part to the first radiation part.

Optionally, the electronic device includes a foldable screen, the foldable screen includes a main screen and a secondary screen, the main screen is correspondingly disposed in the first part, and the secondary screen is correspondingly disposed in the second part. Therefore, an application scenario of the solution is clarified. That is, the first radiation part is disposed on the main screen and used as the main screen antenna. The second radiation part is disposed on the secondary screen.

Optionally, the first radiation part includes: a first radiator and a second radiator. One end of the first radiator is coupled to a feed, and the other end of the first radiator is coupled to a reference ground. One end of the second radiator close to the first radiator is disposed in a suspended manner, and one end of the second radiator away from the first radiator is coupled to the reference ground. In this way, a schematic composition diagram of the main screen antenna corresponding to the first radiation part is provided. Based on this composition, the first radiation part may form a left-hand and parasitic structure, so that the first frequency band is covered by exciting a CM mode, and the second frequency band is covered by exciting a DM mode. It should be noted that in a specific implementation process of this application, the antenna may further achieve a broadband coverage effect through coverage in a left-hand mode and a parasitic mode. For example, a broadband part between the first frequency band and the second frequency band is covered jointly through the left-hand mode, the CM mode, the parasitic mode, and the DM mode.

Optionally, a length of the first radiator corresponds to a quarter of a wavelength of the first frequency band, and a length of the second radiator corresponds to the quarter of the wavelength of the second frequency band. In this way, a specific limitation on the lengths of the first radiator and the second radiator is provided.

Optionally, the electronic device is in the closed state. During operation of the terminal antenna, a current direction on the second radiation part is the same as a current direction on the first radiation part. In this way, it can be avoided that due to occurrence of a reverse current on the second radiation part, normal radiation of the first radiation part is affected when the first radiation part is approached.

Optionally, that a current direction on the second radiation part is the same as a current direction on the first radiation part includes: a common mode CM mode is excited on the first radiation part to cover the first frequency band. A current direction corresponding to the CM mode is a first direction. The current direction on the second radiation part is the first direction.

Optionally, that a current direction on the second radiation part is the same as a current direction on the first radiation part includes: a differential mode DM mode is excited on the first radiation part to cover the second frequency band. A current direction corresponding to the DM mode is from two ends to the middle. The current direction on the second radiation part is from two ends to the middle. Alternatively, a current direction corresponding to the DM mode is from the middle to two ends. The current direction on the second radiation part is from the middle to two ends.

Optionally, the electronic device is in the closed state. The second radiation part includes at least one first radiation unit. The first radiation unit excites a quarter-wavelength mode to radiate during operation of the electronic device, and a frequency band corresponding to the radiation of the first radiation unit is higher than the second frequency band.

Optionally, the electronic device is in the closed state. The second radiation part includes at least one second radiation unit. The first radiation unit excites a half-wavelength mode to radiate during operation of the electronic device, and a frequency band corresponding to radiation of the second radiation unit is higher than the second frequency band.

In this way, resonance of a secondary screen radiator is controlled to be above the second frequency band, so that no reverse current occurs on the secondary screen radiator. Further, it is ensured that when the second radiation part approaches the first radiation part, normal operation of the first radiation part is not affected.

Optionally, when the second radiation part includes two or more radiation units, adjacent radiation units are separated through a gap. In different implementations, one or more first radiation units and/or one or more second radiation units included in the second radiation part may be separated through a gap.

According to a second aspect, an electronic device is provided. The terminal antenna according to the first aspect and any possible design of the first aspect is disposed in the electronic device.

Optionally, the electronic device is a foldable device. The electronic device includes a first part and a second part, and the first part is connected to the second part through a folding axis. When the electronic device is in a closed state, the first part and the second part are interlocked with each other, and when the electronic device is in an unfolded state, the first part and the second part are in a same plane.

Optionally, when the electronic device is in the unfolded state, a signal is transmitted or received through a first radiation part in the terminal antenna; and when the electronic device in the closed state, a signal is transmitted or received through the first radiation part and a second radiation part in the terminal antenna.

It should be understood that, technical features of the technical solution provided in the second aspect may correspond to the terminal antenna provided in the first aspect and a possible design of the first aspect. Therefore, beneficial effects that can be achieved are similar and details are not described herein again.

### BRIEF DESCRIPTION OF DRAWINGS

FIG. 1 is a schematic diagram of a foldable mobile phone in different folded state;

FIG. 2 is a schematic diagram of a foldable mobile phone with a metal frame architecture;

FIG. 3 is a schematic composition diagram of a main screen antenna of a foldable electronic device;

FIG. 4 is a schematic diagram of a closed state of no metal material disposed on a secondary screen of a foldable electronic device;

FIG. 5 is a schematic diagram of S-parameter simulation of an antenna composition shown in FIG. 4;

FIG. 6 is a schematic diagram of current simulation of an antenna composition shown in FIG. 4;

FIG. 7 is a schematic diagram of logic of an antenna disposed on an electronic device according to an embodiment of this application;

FIG. 8 is a schematic composition diagram of logic of a second radiation part according to an embodiment of this application;

FIG. 9 is a schematic diagram of an antenna solution according to an embodiment of this application;

FIG. 10 is a schematic diagram of an antenna solution according to an embodiment of this application;

FIG. 11 is a schematic diagram of S-parameter simulation according to an embodiment of this application;

FIG. 12 is a schematic diagram of an antenna solution according to an embodiment of this application;

FIG. 13 is a schematic diagram of simulation according to an embodiment of this application;

FIG. 14 is a schematic diagram of an antenna solution according to an embodiment of this application;

FIG. 15 is a schematic diagram of simulation according to an embodiment of this application;

FIG. 16 is a schematic diagram of simulation according to an embodiment of this application;

FIG. 17 is a schematic diagram of an antenna solution according to an embodiment of this application;

FIG. 18 is a schematic diagram of S-parameter simulation according to an embodiment of this application;

FIG. 19 is a schematic diagram of an antenna solution according to an embodiment of this application;

FIG. 20 is a schematic diagram of simulation according to an embodiment of this application;

FIG. 21 is a schematic diagram of an antenna solution according to an embodiment of this application;

FIG. 22 is a schematic diagram of an antenna solution according to an embodiment of this application;

FIG. 23 is a schematic diagram of simulation according to an embodiment of this application;

FIG. 24 is a schematic diagram of an antenna solution according to an embodiment of this application;

FIG. 25 is a schematic diagram of an antenna solution according to an embodiment of this application;

FIG. 26 is a schematic diagram of S-parameter simulation according to an embodiment of this application;

FIG. 27 is a schematic diagram of an antenna solution according to an embodiment of this application;

FIG. 28 is a schematic diagram of S-parameter simulation according to an embodiment of this application;

FIG. 29 is a schematic diagram of current simulation according to an embodiment of this application;

FIG. 30 is a schematic diagram of an antenna solution according to an embodiment of this application; and

FIG. 31 is a schematic diagram of simulation of S-parameter according to an embodiment of this application.

### DESCRIPTION OF EMBODIMENTS

One or more antennas may be disposed in an electronic device, to achieve receiving and transmitting of a radio signal. The electronic device may include a foldable device provided with a foldable screen.

First, the foldable device involved in embodiments of this application is briefly introduced in the following.

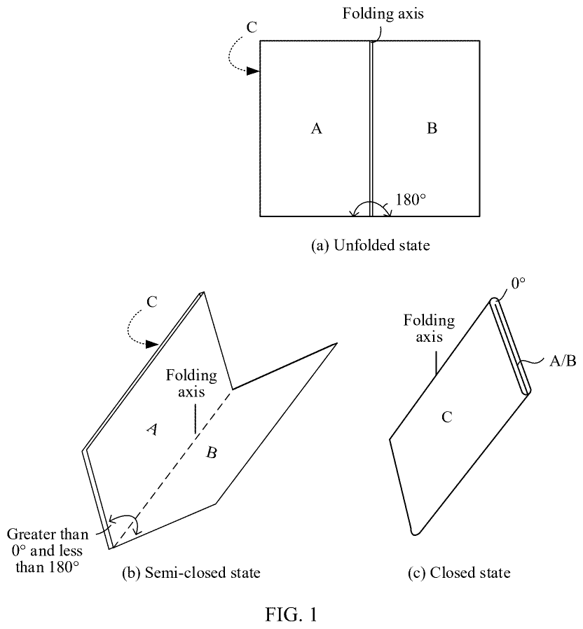

For example, FIG. 1 shows an example of a foldable device in different states. An example in which the foldable device is a foldable mobile phone is used. A foldable screen may be disposed on an inner side of the foldable device, and the foldable screen may include a screen A and a screen B shown in FIG. 1. In different implementations, the screen A and the screen B may be different parts of the same screen, or the screen A and the screen B may be two independent screens. Correspondingly, a display screen, such as a screen C, may further be disposed on an outer side of the foldable device.

In the example shown in FIG. 1, the screen C may be a screen disposed opposite to the screen A.

As shown in FIG. 1, states of the foldable device may include an unfolded state shown in (a) in FIG. 1, a closed state (or referred to as a folded state) shown in (c) in FIG. 1, and a semi-closed state (or referred to as a semi-folded state) between the unfolded state and the closed state shown in (b) in FIG. 1.

When the foldable device is in the unfolded state, a folded angle is 180 degrees, and the screen A and the screen B are in a same plane.

When the foldable device is in the closed state, the folded angle is 0 degrees, the screen A and the screen B are interlocked with each other, and the screen C is correspondingly located on an exterior surface of the foldable device.

Correspondingly, when the foldable device is in the semi-closed state, the folded angle is between 0 degrees and 180 degrees.

One or more antennas may be disposed in the foldable device, to support a wireless communication function of the foldable device.

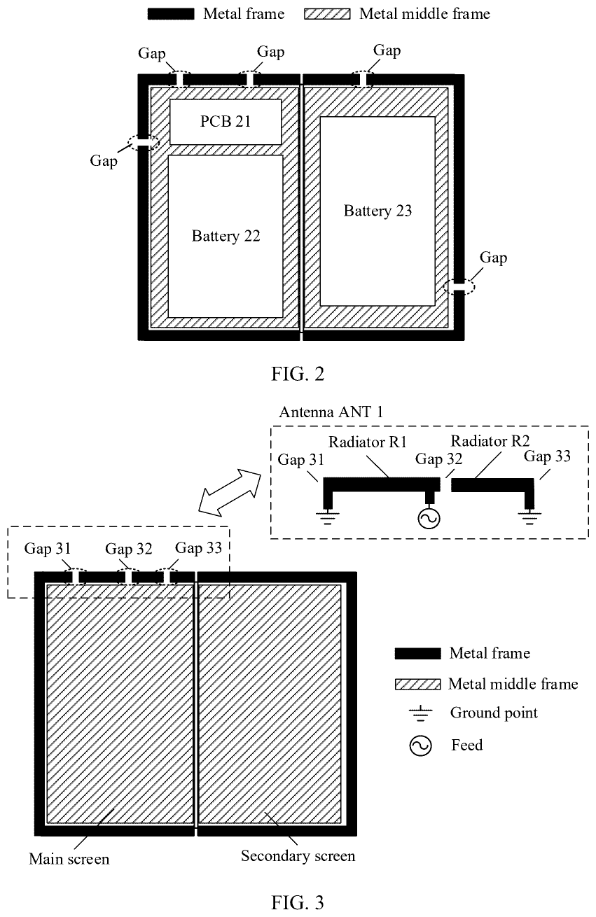

An example in which the foldable device has a metal frame architecture is used. FIG. 2 shows a structural example of a foldable device.

As shown in FIG. 2, a metal frame may be disposed on a side edge of the foldable device, so that the side edge of the foldable device may have a metal texture. In addition, because strength of a metal material is significantly greater than that of plastic, structural strength and stability of the foldable device are ensured.

In the example shown in FIG. 2, one or more through gaps may further be provided on the metal frame. The through gap may break the metal frame into a plurality of metal bars that are independent of each other. In this way, disposition of the antenna in the foldable device may be implemented through the metal bar on the metal frame as a radiator of the antenna.

A metal middle frame may be further disposed inside the metal frame. As shown in FIG. 2, the metal middle frame may cover most regions of the foldable device, to provide overall rigid support. In some embodiments, the metal middle frame may further provide a zero potential reference for electronic components in the foldable device based on a large metal area.

For example, the metal middle frame may be coupled to the radiator of the antenna, to implement grounding of the antenna. For another example, the metal middle frame may provide a zero potential reference for a printed circuit board (PCB) disposed in the electronic device and electronic components and lines carried on the PCB.

In the example shown in FIG. 2, a PCB 21 may be disposed in the electronic device. The PCB 21 may be configured to carry a chip, a circuit, an electronic component, and the like in the foldable device. For example, a baseband chip, a radio frequency module, and the like may be disposed on the PCB 21. In this way, through cooperation of the baseband chip and the radio frequency module, a feed signal is provided to the antenna to transmit the signal to the outside, or a radio signal is received through the antenna, and effective information carried in the radio signal is obtained through processing performed by the radio frequency module and the baseband chip, so as to achieve reception of the signal.

It should be noted that the PCB 21 shown in FIG. 2 is merely an example. In some other implementations, a quantity and a position of PCBs disposed in the foldable device may also be different from those in the example in FIG. 2.

As shown in FIG. 2, a battery may be further disposed in the foldable device to supply power to the foldable device. For example, a quantity of the battery may be one or more. In the example shown in FIG. 2, the battery may include a battery 22, a battery 23, and the like.

In the following description, an example in which the foldable device has the architecture shown in FIG. 2 is used for description. It may be understood that, in another embodiment, the foldable device may alternatively have another architecture. For example, the foldable device may be folded up and down. For another example, the foldable device may be a partial metal frame architecture or a non-metal frame architecture. A specific implementation of the foldable device is not limited in embodiments of this application.

With reference to the foregoing description of FIG. 1 and FIG. 2, referring to FIG. 3, an example in which an antenna is disposed at the top of the foldable device is used. FIG. 3 provides an example of composition logic of an antenna ANT 1. In this example, the antenna may be disposed in a metal frame region at the top of the main screen. That is, the radiator of the antenna may reuse a part of the metal frame at the top of the main screen. The main screen may correspond to the screen A in the foregoing example. Correspondingly, the secondary screen is the screen B in the foregoing example. In some other implementations, the main screen may alternatively correspond to the screen B in the foregoing example, and then a corresponding secondary screen is the screen A in the foregoing example.

As shown in FIG. 3, one or more gaps may be provided on the metal frame at the top of the main screen. For example, in the example shown in FIG. 3, the antenna ANT 1 may be separated from other frames through a gap 31 and a gap 33. A gap 32 may be further provided on the ANT 1, so that a radiator of the ANT 1 may include two segments of independent radiators. For example, the two radiators may include a radiator R1 and a radiator R2.

One end, of the resistor R1, away from the radiator R2 is grounded. One end, of the radiator R1, close to the radiator R2 is connected to a feed. One end, of the radiator R2, away from the radiator R1 is grounded. In some implementations, a series capacitor may be disposed between the radiator R1 and the feed, so that the radiator R1 can radiate by operating in the left-hand mode. Correspondingly, the radiator R2 may be coupled through the gap 32, to obtain an effect of parasitic radiation. In some implementations, a width of the gap 32 may be less than or equal to 5 mm. Further, the width of the gap 32 may be less than or equal to 2.5 mm.

During operation of the antenna ANT 1 shown in FIG. 3, the left-hand mode, the common mode (CM) mode, the parasitic mode, and the differential mode (DM) mode may be separately excited, to cover at least two frequency bands. In some implementations, the at least two frequency bands may include a first frequency band, a second frequency band, and a part between the first frequency band and the second frequency band. That is, the antenna ANT 1 may jointly cover a frequency band from the first frequency band to the second frequency band through the left-hand mode, the CM mode, the parasitic mode, and the DM mode.

It may be understood that the antenna ANT 1 shown in FIG. 3 is merely an example. The antenna ANT 1 may be configured to cover at least two frequency bands in 2G, 3G, 4G, 5G, and/or 6G cellular communication. The antenna ANT 1 may be further configured to cover a 2.4 GHz or 5 GHz Wi-Fi frequency band in short range communication, a GPS frequency band, and/or the like. In addition, in some other embodiments, a form of the antenna disposed in the foldable device may also be different from the antenna ANT 1 shown in FIG. 3. In some other embodiments, a position of the antenna disposed in the foldable device may alternatively be different from the antenna ANT 1 shown in FIG. 3. For example, the antenna ANT 1 is disposed on a side edge or a bottom edge of the foldable device. This is not limited in embodiments of this application.

With reference to the description in FIG. 1, when the foldable device is used, the foldable device includes at least the unfolded state and the closed state. In the example shown in FIG. 3, in the unfolded state, an environment near the antenna ANT 1 is open, and therefore, good radiation performance can be provided.

However, in the closed state, proximity of metal materials such as a metal frame on the secondary screen and a metal middle frame close to a top frame significantly affects operation of the antenna ANT 1.

As a comparison in an ideal state, in the closed state, a region in which the antenna ANT 1 is projected onto the secondary screen may be configured as a non-conductive material. Therefore, impact of the metal material on the secondary screen on the antenna ANT 1 in the closed state is reduced to the greatest extent.

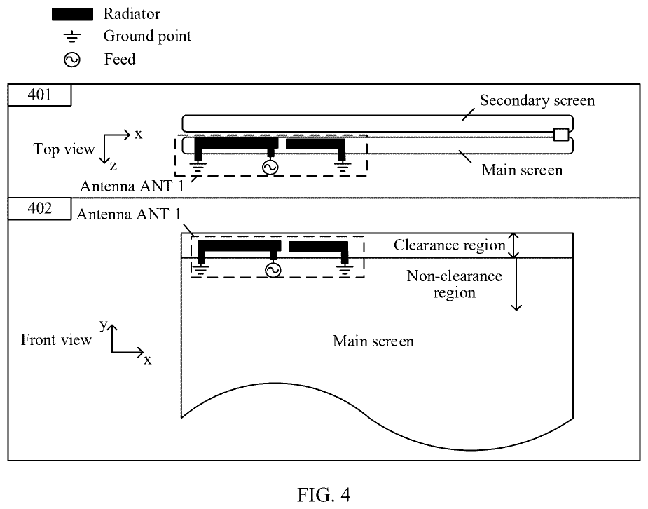

For example, FIG. 4 is a schematic diagram of different viewing angles in a closed state when the ANT 1 is disposed in the foldable device shown in FIG. 3.

As shown in 401 in FIG. 4, in a top view, an antenna ANT 1 is disposed on a main screen, and a corresponding region on a secondary screen does not include a radiator (that is, does not include a metal material).

As shown in 402 in FIG. 4, in a front view, the antenna ANT 1 on the main screen may be disposed in a clearance region. The clearance region may be a region that is on a periphery of the metal middle frame and that is in the foldable device and in which no (or few) metal materials or devices are disposed. Reservation of the clearance region may enable the antenna (such as the antenna ANT 1) to obtain a good radiation space.

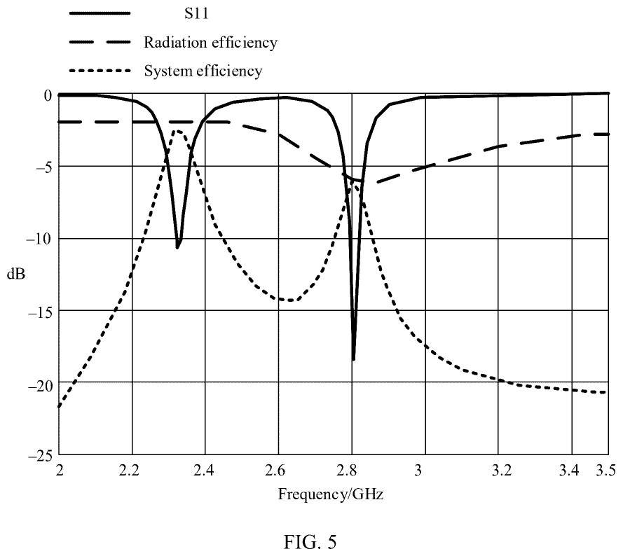

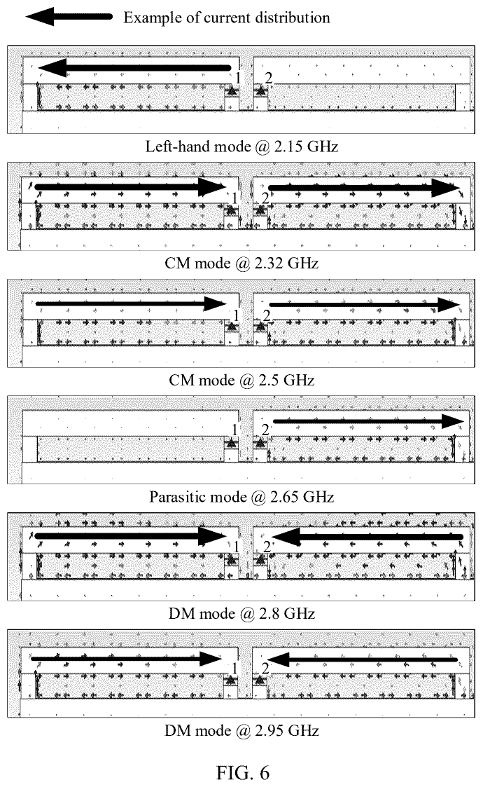

Corresponding simulation results are shown in FIG. 5 and FIG. 6 during operation of the antenna ANT 1 in the foldable device disposed as shown in FIG. 4 in the closed state.

It should be noted that, in the following examples of this application, all simulation examples are given by using an example in which the electronic device is in the closed state. Details are not described below again.

FIG. 5 shows an example of S-parameter simulation of an antenna disposition shown in FIG. 4. An example in which a length of the radiator R1 is 15 mm and a length of the radiator R2 is also 15 mm is used.

As shown in a single-port return loss (S11) curve in FIG. 5, during operation of the antenna ANT 1, the antenna ANT 1 may cover at least two operating frequency bands: a frequency band around 2.32 GHz and a frequency band around 2.8 GHz. As shown in a curve of system efficiency and radiation efficiency in FIG. 5, during operation of the antenna ANT 1, the radiation efficiency may reach above −2 dB around 2.3 GHz. Correspondingly, in a current port matching state, the system efficiency may exceed −3 dB around 2.3 GHZ, and approaches −2 dB. At a high frequency around 2.8 GHz, the radiation efficiency may exceed −6 dB, and the system efficiency may approach −6 dB. Therefore, in an ideal environment, the antenna ANT 1 may provide good radiation performance in two operating frequency bands (for example, the frequency band around 2.3 GHz and the frequency band around 2.8 GHz).

FIG. 6 shows an example of current simulation of the antenna disposition shown in FIG. 4 at different frequency points.

As shown in FIG. 6, at 2.15 GHZ, a current is mainly distributed on a left-side radiator (such as the radiator R1). The current is distributed in the same direction from the feed to the ground. The distribution feature conforms to current distribution of the left-hand mode. That is, during operation of the antenna ANT 1, the antenna ANT 1 may cover 2.15 GHz through the left-hand mode distributed on the radiator R1.

At 2.32 GHz, a current is mainly distributed on the left-side radiator and a right-side radiator (such as the radiator R2). The current is distributed on the two radiators in the same direction. The distribution feature conforms to current distribution of the CM mode. That is, during operation of the antenna ANT 1, the antenna ANT 1 may cover 2.32 GHz through the CM mode distributed on the radiator R1 and the radiator R2.

Corresponding to the S11 curve shown in FIG. 5, the left-hand mode and the CM mode may be jointly used to cover a frequency band around 2.32 GHz. The CM mode has a large radiation contribution, and the left-hand mode may be used for extending a low frequency bandwidth.

Still with reference to FIG. 6, at 2.5 GHz, the current is mainly distributed on the left-side radiator and the right-side radiator (for example, the radiator R2). The current is distributed on the two radiators in the same direction. The distribution feature conforms to current distribution of the CM mode. Compared with the CM mode covering 2.32 GHz, current strength on the radiator R1 and the radiator R2 is reduced.

At 2.65 GHz, the current is mainly distributed on the right-side radiator (such as the radiator R2). Corresponding to operation of the antenna ANT 1, the antenna ANT 1 convers 2.65 GHz through a quarter-wavelength parasitic mode distributed on the radiator R2.

As the frequency further increases, current distribution in the DM mode occurs on the radiator.

For example, at 2.8 GHz, the current is distributed on both the radiator R1 and the radiator R2. A current of the radiator R1 is opposite to a current of the radiator R2. The distribution feature conforms to current distribution of the DM mode. That is, during operation of the antenna ANT 1, the antenna ANT 1 covers 2.8 GHz through the DM mode distributed on the radiator R1 and the radiator R2.

Further, at 2.95 GHz, the current is distributed on both the radiator R1 and the radiator R2. The current of the radiator R1 is opposite to the current of the radiator R2. The distribution feature conforms to current distribution of the DM mode. Compared with the DM mode covering 2.8 GHz, current strengths on the radiator R1 and the radiator R2 are reduced.

In this way, through current simulation at a plurality of frequency points provided in FIG. 6, the following conclusion may be drawn: In the antenna disposition shown in FIG. 4, the antenna ANT 1 may cover both a low frequency band (for example, a frequency band around 2.3 GHz) and a high frequency band (for example, a frequency band around 2.8 GHZ) during operation. The low frequency band may be covered through the CM mode (or the CM mode and the left-hand mode). The high frequency band may be covered through the DM mode.

The foregoing uses FIG. 4 to FIG. 6 to describe in detail an operating status in the ideal state in a case in which the antenna ANT 1 is disposed in the foldable device and the foldable device is in the closed state. It may be understood that in an actual implementation process, due to limitations such as an appearance ID, when the antenna (for example, the antenna ANT 1) is disposed on a frame of the main screen, a region in which the antenna is projected to the secondary screen in the closed state usually includes a metal material such as a frame of the secondary screen. In this way, compared with the disposition in the ideal environment shown in FIG. 4, radiation of the antenna (for example, the antenna ANT 1) on the frame of the main screen in a case in which the foldable device is in the closed state is significantly affected.

To resolve impact of a metal material such as a frame of the secondary screen on the main screen antenna (for example, a main screen frame antenna) in the closed state, an embodiment of this application provides an antenna solution. A secondary screen frame is disposed in a targeted manner, so that even in the closed state, the main screen frame antenna can also provide radiation performance close to that in the disposition in the ideal environment shown in FIG. 4.

The antenna solution provided in embodiments of this application is described below in detail with reference to the accompanying drawings.

It should be noted that, the electronic device in embodiments of this application may include at least one of a mobile phone, a foldable electronic device, a tablet computer, a laptop computer, a handheld computer, a notebook computer, an ultra-mobile personal computer (UMPC), a netbook, a cellular phone, a personal digital assistant (PDA), an augmented reality (AR) device, a virtual reality (VR) device, an artificial intelligence (AI) device, a wearable device, a vehicle-mounted device, a smart home device, or a smart city device. A specific type of the electronic device 100 is not specially limited in embodiments of this application.

In some embodiments, the antenna solution provided in embodiments of this application may be applied to the electronic device (such as the foregoing foldable device) provided with the foldable screen.

In an example, the electronic device may have the composition shown in FIG. 1 or FIG. 2. With reference to the description in FIG. 1 and FIG. 2, in this application, the electronic device may include a metal floor structure (for example, the foregoing metal middle frame), a PCB (for example, the foregoing PCB 21), a battery (for example, the foregoing battery 22 and battery 23), an antenna radiation stub, a medium, and the like.

In some implementations, the antenna radiation stub may be disposed by reusing a metal structure on the electronic device. For example, the antenna radiation stub may be disposed by reusing the metal frame. For another example, the antenna radiation stub may be formed by coring out a part in the metal floor structure.

In some other implementations, the antenna radiation stub may also be disposed on the electronic device in another form. For example, the antenna radiation stub is implemented in a form like a flexible printed board (FPC), metalframe diecasting for anodicoxidation (MDA), or laser direct structuring (LDS).

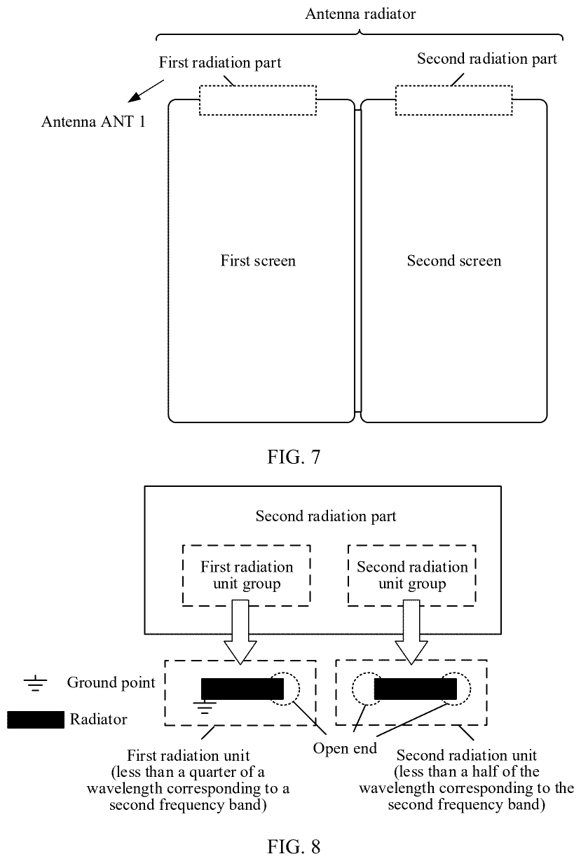

In embodiments of this application, as shown in FIG. 7, the radiator radiation stub (or referred to as the radiator) may include the first radiation part and the second radiation part. The first radiation part may be disposed in a corresponding region (for example, a first part of the electronic device) of a first screen, and the second radiation part may be disposed in a corresponding region (for example, a second part of the electronic device) of a second screen. The first screen and the second screen may be two screens that are interlocked with each other when the electronic device is in the closed state. For example, the first screen may be the screen A as described in FIG. 1, and the second screen may be the screen B as described in FIG. 1. For another example, the first screen may be the main screen in the foregoing example, and the second screen may be the secondary screen in the foregoing example.

Using an example in which the first radiation part is disposed in a main screen region (that is, the first part of the electronic device), and the first radiation part may also be referred to as a main screen radiator. Correspondingly, if the second radiation part is disposed in a secondary screen region, the second radiation part may also be referred to as a secondary screen radiator.

When the electronic device is in the closed state, a projection of the main screen radiator onto the secondary screen at least partially overlaps a region in which the secondary screen radiator is located. In some embodiments, a region of the projection of the main screen radiator onto the secondary screen may be included in a region in which the secondary screen radiator is located. In this way, the secondary screen radiator is disposed in a targeted manner, so that when the electronic device is in the closed state, radiation of the main screen radiator is not significantly deteriorated due to the metal material on the secondary screen. In some other embodiments, the region of the projection of the main screen radiator onto the secondary screen may alternatively be smaller than a region in which the secondary screen radiator is located. In this example, the region of the projection of the main screen radiator onto the secondary screen may include the secondary screen radiator. The remaining part may be configured as the clearance region. Therefore, it is avoided that when the electronic device is in the closed state, another metal material other than the secondary screen radiator is disposed on the secondary screen in a region close to the main screen radiator, resulting in degradation of performance of the main screen antenna.

The following separately describes the main screen radiator (that is, the first radiation part) and the secondary screen radiator (that is, the second radiation part) in the solutions provided in embodiments of this application by using examples.

In some embodiments, at least one feed point may be disposed on the main screen radiator. The main screen radiator may be coupled to the feed at a position of the feed point through an electrical connection component such as a metal elastic piece. For example, the main screen radiator may be coupled to a radio frequency link on the PCB through the metal elastic piece at the position of the feed point. In this way, feeding of the main screen radiator is achieved through the feed. In some other embodiments, at least one ground point may be disposed on the main screen radiator. The main screen radiator may be coupled to the reference ground on the PCB at a ground point position through an electrical connection component such as a metal elastic piece.

The main screen radiator, the feed, and the ground point may logically form the main screen antenna. In some implementations, the main screen antenna may have a composition of the antenna ANT 1 shown in FIG. 3. In a possible description manner, the main screen antenna may be described as follows: The main screen antenna may include a first radiator (corresponding to the radiator R1) and a second radiator (corresponding to the radiator R2). An end of the first radiator and an end of the second radiator are separated through a gap (corresponding to the gap 32). A length of the first radiator is determined based on the quarter of the wavelength of the first frequency band, and a length of the second radiator is determined based on the quarter of the wavelength of the second frequency band. The first frequency band and the second frequency band are operating frequency bands covered by the main screen antenna during operation of the main screen antenna. The first frequency band is lower than the second frequency band in frequency domain.

One end, of the first radiator, close to the second radiator is provided with the feed. One end, of the first radiator, away from the second radiator is provided with the ground point. One end, of the second radiator, close to the first radiator is an open end, and one end, of the second radiator, away from the first radiator is provided with the ground point.

In some embodiments, a matching circuit may be disposed between the first radiator and the feed. For example, the matching circuit may include a series capacitor, configured to excite the left-hand mode on the first radiator. In some other embodiments, the matching circuit may also be disposed between the ground point of the first radiator and/or the second radiator and the reference ground, to implement frequency domain tuning and/or port resistance tuning of a corresponding mode.

With reference to the description of FIG. 3 to FIG. 6, in this example, the main screen antenna may cover the first frequency band by exciting the CM mode (or the CM mode and the left-hand mode), and cover the second frequency band through the DM mode (or the DM mode and the parasitic mode).

As shown in FIG. 7, in embodiments of this application, the second radiation part may be further disposed on the second screen of the electronic device.

For example, referring to FIG. 8, in embodiments of this application, the second radiation part (that is, the secondary screen radiator) may include a first radiation unit group and/or a second radiation unit group.

The first radiation unit group may include at least one first radiation unit. A ground point is disposed on the first radiation unit. The ground point may be located at any position on the first radiation unit. The first radiation unit includes at least one open end. When the secondary screen radiator includes a plurality of first radiation units, lengths of any two first radiation units may be the same or may be different.

In this application, a length of any first radiation unit is less than a quarter of a wavelength corresponding to the second frequency band.

It should be noted that, in the description of embodiments of this application, the length of the radiation unit/radiator may be limited through a wavelength of a frequency band. For example, “a length of the first radiation unit is less than a quarter of a wavelength corresponding to the second frequency band” may be understood as: The length of the first radiation unit is less than a corresponding length of the quarter of the wavelength corresponding to the second frequency band. It may be understood that when the first radiation unit is implemented by using a conductive material having different electrical parameters, such as a different dielectric constant and a different loss tangent, a corresponding length of the quarter of the wavelength corresponding to the second frequency band may be different. In a specific implementation process, a specific size corresponding to the quarter of the wavelength corresponding to the second frequency band may be comprehensively determined through calculation by using an electrical parameter of a conductive material for implementing the first radiation unit, in combination with the quarter of the wavelength of a center frequency (or an endpoint frequency point) of the second frequency band. In the following solution example, defining the length of the radiation unit/radiator through the wavelength follows the description, and details are not described again.

The second radiation unit group may include at least one second radiation unit. Two ends of the second radiation unit are disposed in a suspended manner. That is, two ends of the second radiation unit group are open ends.

In this application, a length of any second radiation unit is less than a half of a wavelength corresponding to the second frequency band.

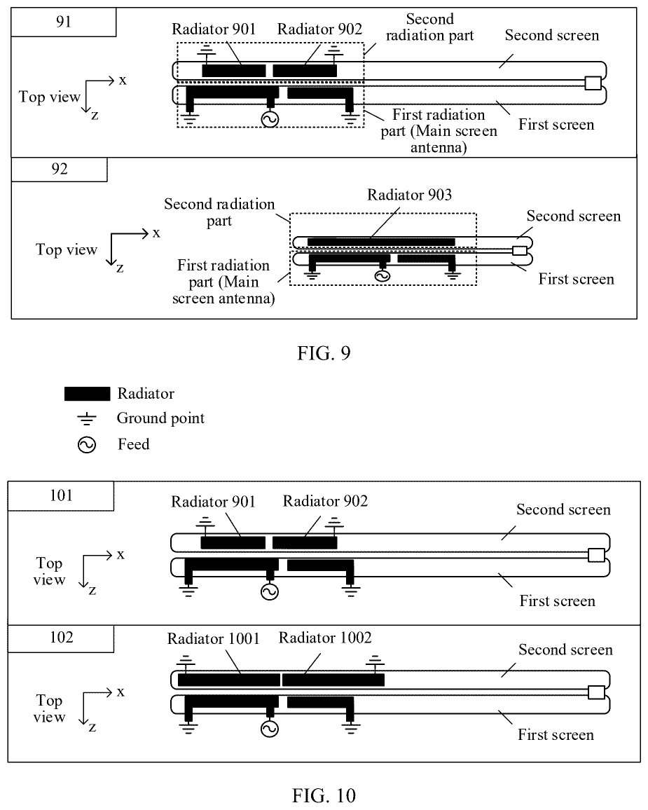

FIG. 9 shows two composition examples of an antenna (or referred to as a terminal antenna) including the foregoing first radiation part and second radiation part.

As shown in 91 of FIG. 9, the antenna may include the first radiation part and the second radiation part. The first radiation part is located on the first screen. For example, the first radiation part is located at a top edge of the first screen. In this example, the first radiation part has a composition feature of the foregoing antenna ANT 1, and is used as the main screen antenna to cover the first frequency band and the second frequency band.

The second radiation part is located on the second screen. When the electronic device is in the closed state, the projection of the first radiation part onto the second screen at least partially coincides with the second radiation part.

In the example of 91, an example in which the second radiation part includes two first radiation units is used. The two first radiation units may include a radiator 901 and a radiator 902. A length of the radiator 901 or the radiator 902 is less than a quarter of a wavelength of the second frequency band.

As shown in 92 of FIG. 9, an example in which the second radiation part includes one second radiation unit is used. The one second radiation unit may include a radiator 903. A length of the radiator 903 is less than a half of the wavelength of the second frequency band.

It may be understood that when the second radiation part is used as a parasitic stub to obtain, in a form of coupling, energy from the first radiation part to perform radiation, an antenna solution 92 in FIG. 9 is used as an example, for the second radiation unit (for example, the radiator 903) in any second radiation part, because two ends are open ends, the half-wavelength mode may be stimulated for operation. An example in which the length of the second radiation unit (for example, the radiator 903) is a length L1 is used. Therefore, during operation of the second radiation unit, a corresponding wavelength of a resonant frequency of a fundamental mode generated by the second radiation unit should correspond to 2*L1. With reference to the foregoing description about the second radiation unit, due to the limitation in this application that the length (L1) of the second radiation unit (for example, the radiator 903) is less than the half of the wavelength of the second frequency band, in a frequency domain position, a parasitic resonance generated on the second radiation unit is higher than the second frequency band. In this way, when operating at a frequency lower than the second frequency band (for example, a frequency band between the second frequency band and the first frequency band) in frequency domain, the second radiation unit does not generate a current opposite to that on the first radiation part. In this way, in a frequency range lower than the second frequency band, a direction of a current generated on the second radiation unit is the same as a direction of a current generated on the first radiation unit. Therefore, when the electronic device is in the closed state, even if the second radiation part is close to the first radiation part, radiation of the first radiation unit (that is, the main screen antenna) is not negatively affected.

Based on a similar reason, when the second radiation part includes the first radiation unit, an antenna solution 91 in FIG. 9 is used as an example, because one end of the first radiation unit (for example, the radiator 901 or the radiator 902) is grounded, the quarter-wavelength mode may be excited on the first radiation unit through a parasitic effect. In this way, in this application, the length of the first radiation unit (for example, the radiator 901 or the radiator 902) is configured to be less than a quarter of the wavelength of the second frequency, so that a parasitic resonance generated by the first radiation unit is higher than the second frequency band. In this way, in frequency domain between the first frequency band and the second frequency band, current distribution on the second radiation part keeps the same as that on the first radiation part. Therefore, when the electronic device is in the closed state, even if the second radiation part is close to the first radiation part, radiation of the first radiation unit (that is, the main screen antenna) is negatively affected.

The following describes, with reference to simulation comparison, an impact of different lengths of radiators in the second radiation part on overall radiation of the antenna when the first radiation unit or the second radiation unit is disposed in the second radiation part. Therefore, the foregoing description is supported.

For example, an example in which the second radiation part includes the first radiation unit is used. With reference to an example in the antenna solution 91 in FIG. 9, refer to FIG. 10.

FIG. 10 provides two antenna solutions, that is, an antenna solution 101 and an antenna solution 102. Main screen antennas in the two antenna solutions have same settings.

In the antenna solution 101, a disposition of the second radiation part is the same as that in the antenna solution 91. That is, in the antenna solution 101, the second radiation part may include the radiator 901 and the radiator 902, and a length of the radiator 901 and a length of the radiator 902 are both less than the quarter of the wavelength of the second frequency band.

In the antenna solution 102, the second radiation part may include a radiator 1001 and a radiator 1002. A length of the radiator 1001 and a length of the radiator 1002 are both greater than the quarter of the wavelength of the second frequency band.

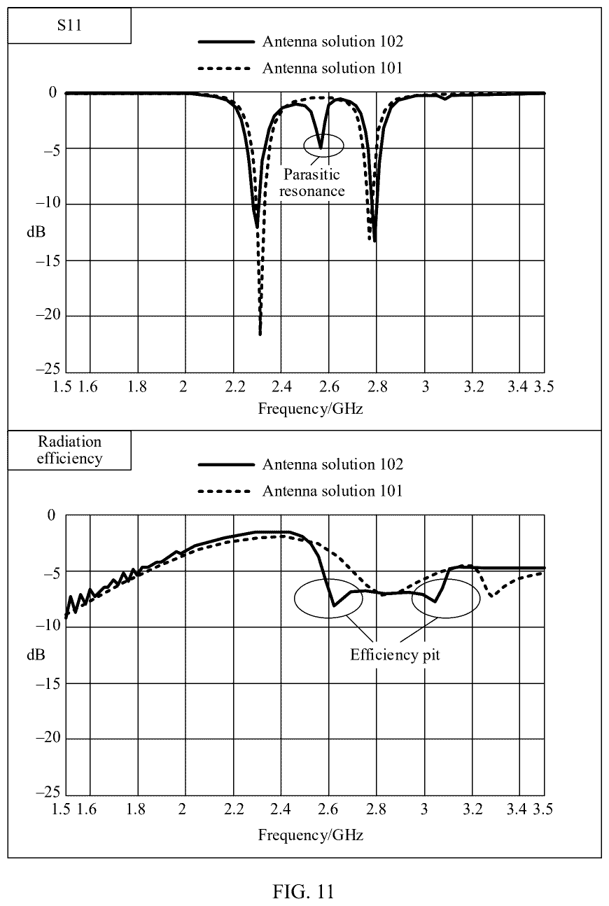

FIG. 11 shows simulation comparison of S-parameters respectively corresponding to the two antenna solutions shown in FIG. 10.

As shown in S11 in FIG. 11, both the antenna solution 101 and the antenna solution 102 may generate a resonance in the frequency band (corresponding to the first frequency band) around 2.3 GHZ, and generate a resonance in the frequency band (corresponding to the second frequency band) around 2.8 GHz.

In the antenna solution 102, because the radiator 1001 and the radiator 1002 are longer, a high frequency resonance and a low frequency resonance are both low. It should be noted that, a parasitic resonance generated due to a parasitic effect in the second radiation part occurs between the high frequency resonance and the low frequency resonance. The parasitic resonance may negatively affect radiation performance in an operating frequency band.

Referring to comparison of radiation efficiency in FIG. 11, around 2.6 GHz at which the parasitic resonance is located, a significant efficiency pit occurs in the antenna solution 102. Correspondingly, in the antenna solution 101, because the length of the first radiation unit is less than the quarter of the wavelength of the second frequency band (that is, a frequency band corresponding to the high frequency resonance), no significant pit occurs in in-band radiation efficiency.

In this way, in this application, the length of the first radiation unit is configured to be less than the quarter of the wavelength of the second frequency band in a targeted manner, so that the parasitic resonance generated by the first radiation unit may be higher than the second frequency band, thereby avoiding impact on normal operation of the first radiation part after the second radiation part approaches the first radiation part in the closed state.

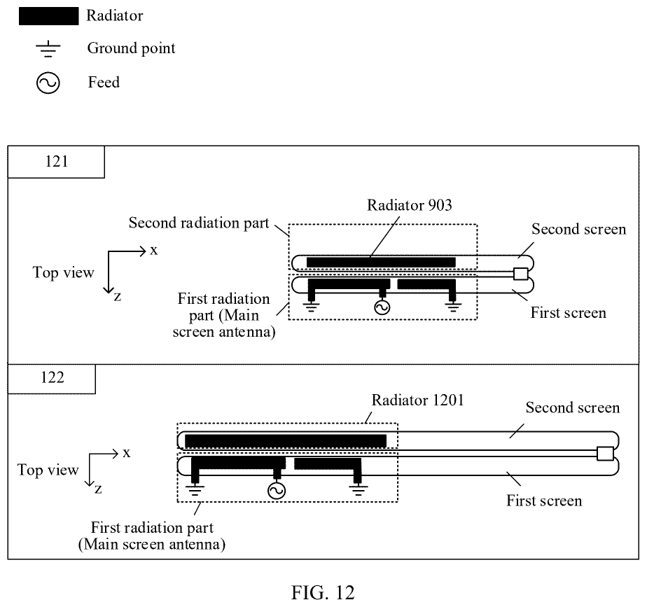

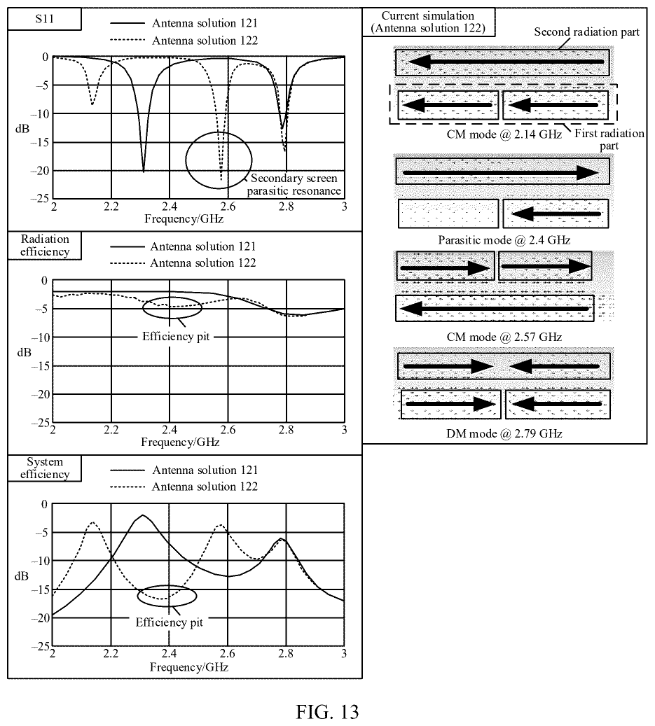

In some other embodiments, an example in which the second radiation part includes the second radiation unit is used. With reference to an example in the antenna solution 92 in FIG. 9, refer to FIG. 12.

FIG. 12 provides two antenna solutions, that is, an antenna solution 121 and an antenna solution 122. Main screen antennas in the two antenna solutions have same settings.

In the antenna solution 121, a disposition of the second radiation part is the same as that in the antenna solution 92. That is, in the antenna solution 121, the second radiation part may include a radiator 903, and a length of the radiator 903 is less than the half of the wavelength of the second frequency band.

In the antenna solution 122, the second radiation part may include a radiator 1201. The length of the radiator 903 is greater than the half of the wavelength of the second frequency band.

FIG. 13 shows simulation comparison of S-parameters respectively corresponding to the two antenna solutions shown in FIG. 12.

An example of comparison of S11 is shown in FIG. 13. The antenna solution 121 may excite a first frequency band around 2.3 GHZ and a second frequency band around 2.8 GHz for operation. The antenna solution 122 excites three resonances. A lowest resonance is covered by the CM mode of the main screen antenna. A highest resonance is covered by the DM mode of the main screen antenna. It may be understood that because the length of the radiator 1201 is greater than the half of the wavelength of the second frequency band (that is, the foregoing highest resonance), a secondary screen parasitic mode generated by the radiator 1201 may fall between the second frequency band and the first frequency band. For example, around 2.55 GHz, a secondary screen parasitic resonance generated by excitation of a secondary screen radiator (that is, the radiator 1201) is further included.

An example of comparison of radiation efficiency is shown in FIG. 13. Compared with the antenna solution 121, the antenna solution 122 generates a significant efficiency pit between 2.4 GHz and 2.6 GHz. An obvious difference can also be seen in system efficiency: Compared with the antenna solution 121, the antenna solution 122 generates a significant efficiency pit around 2.4 GHz.

FIG. 13 further provides an example of current simulation at various frequency points during operation of the antenna solution 122.

It can be learned that, at 2.14 GHZ, a current direction on the first radiation part is the same as a current direction on the second radiation part, and the first radiation part and the second radiation part are in the CM mode. At 2.4 GHz, an obvious reverse current occurs in the parasitic radiator (for example, the radiator R2) in the first radiation part and the second part. This is also one of reasons that an efficiency pit occurs around 2.4 GHz in the antenna solution 122. At 2.57 GHz, a reverse current is distributed on the first radiation part and the second radiation part. Therefore, at the 2.57 GHz frequency band, radiation performance of the antenna solution 122 is also exceptionally reduced. However, at 2.79 GHz, reverse currents are respectively distributed on the first radiation part and the second radiation part, the first radiation part and the second radiation part are in the DM mode, and an overall current distribution on the first radiation part corresponds to an overall current distribution on the second radiation part (that is, current directions on two corresponding regions before and after projection of the first part onto the second part are the same). Therefore, radiation of the second radiation part does not have a negative impact on a radiation difference of the first radiation part. Therefore, at the 2.79 GHz, the antenna solution 122 can provide good radiation performance similar to that of the antenna solution 122.

Based on comparison examples shown in FIG. 12 and FIG. 13, in this application, the length of the second radiation unit is configured to be less than the half of the wavelength of the second frequency band in a targeted manner, so that impact on normal operation of the first radiation part after the second radiation part approaches the first radiation part in the closed state can be effectively avoided. For example, a radiation effect shown by the antenna solution 121 is obtained.

A configuration mechanism of the first radiation unit and the second radiation unit in the second radiation part in the solution example shown in FIG. 9 is briefly described through the description of FIG. 10 to FIG. 13.

It should be noted that in embodiments of this application, a quantity of the first radiation units and/or the second radiation units in the second radiation part is not limited. When the second radiation part includes a plurality of units, the plurality of units may be separated through a gap.

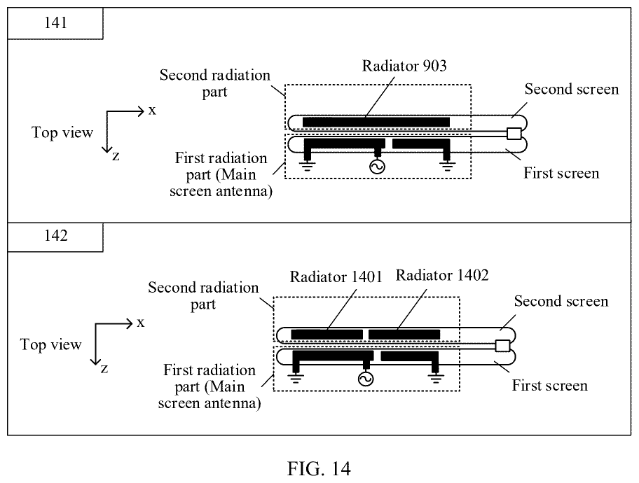

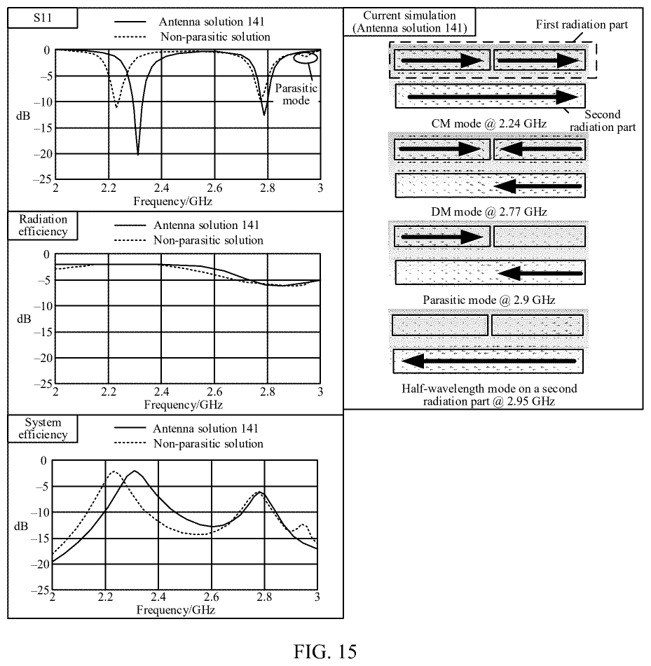

For example, an example in which the second radiation part includes the second radiation unit is used. FIG. 14 provides a schematic diagram of composition of two antenna solutions. In the example shown in FIG. 14, an antenna solution 141 and an antenna solution 142 may be included.

Antenna composition of the antenna solution 141 may correspond to an example of the antenna solution 92 in FIG. 9.

In the antenna solution 142, the second radiation part may include two second radiation units, for example, a radiator 1401 and a radiator 1402. A length of the radiator 1401 and a length of the radiator 1402 are both less than the half of the wavelength of the second frequency band. As shown in FIG. 14, long sides of the radiator 1401 and the radiator 1402 may be disposed on a straight line, and the two radiators are separated through the gap.

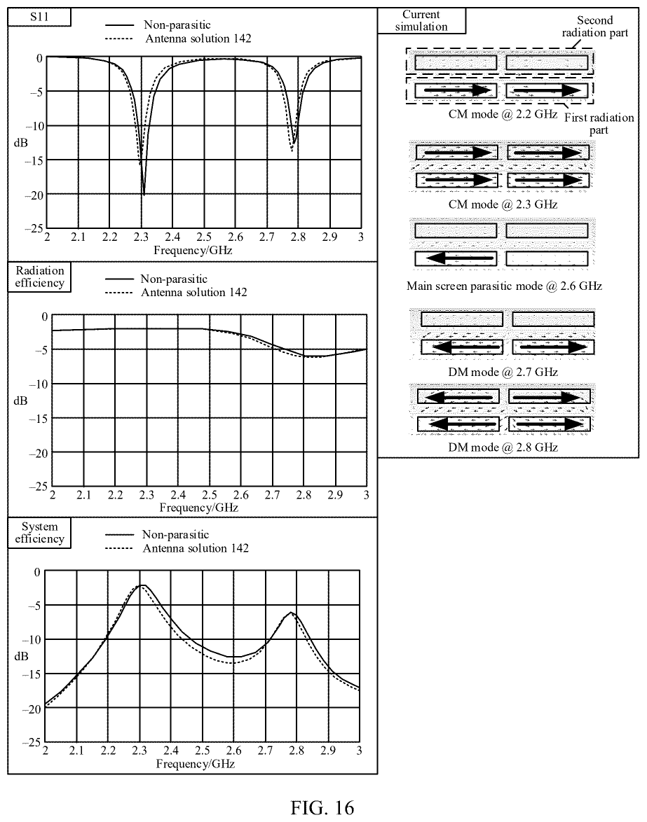

FIG. 15 provides simulation comparison between the antenna solution 141 and a non-parasitic solution in an ideal case shown in FIG. 4. FIG. 16 provides simulation comparison between the antenna solution 142 and the non-parasitic solution. It can be learned that in implementations of the two solutions shown in FIG. 14, when the second radiation part includes one or more second radiation units, the antenna can obtain radiation performance that is basically the same as or similar to that of the non-parasitic solution.

Descriptions are separately provided in the following.

FIG. 15 provides simulation comparison of S-parameters between the antenna solution 141 and the non-parasitic solution and an example of current simulation.

As shown in S11 in FIG. 15, after the second radiation part is added to the antenna solution 141, two resonance depths are both improved to a certain extent, and a bandwidth is also optimized to a certain extent. From the perspective of radiation efficiency, in the antenna solution 141 in which the second radiation part is added, radiation efficiency in an entire frequency band is not lower than that in the non-parasitic solution. From the perspective of system efficiency, an efficiency peak value and an efficiency bandwidth of the antenna solution 141 are basically the same as those of the non-parasitic solution.

Therefore, during operation of the antenna solution 141, while the metal material (for example, the second radiation part) is disposed on the secondary screen, the antenna solution 141 can provide radiation performance close to that in a case in which the metal material is not disposed (for example, the non-parasitic solution).

FIG. 15 further provides an example of current simulation corresponding to frequency points during operation of the antenna solution 141.

At 2.24 GHz, two radiators of the first radiation part are directly distributed with co-directional currents, and the currents are in the CM mode. In addition, a current direction on the second radiation part is the same as a current direction on the first radiation part. Therefore, at 2.24 GHz, disposition of the second radiation part does not have a negative impact on normal radiation of the first radiation part.

At 2.77 GHz, two radiators of the first radiation part are directly distributed with reverse currents, and the currents are in the DM mode. A local current direction on the second radiation part is the same as a current direction at a corresponding position on the first radiation part (for example, from right to left). The other part of the second radiation part has no significant current distribution. Therefore, at 2.77 GHz, disposition of the second radiation part does not have a negative impact on normal radiation of the first radiation part.

At 2.9 GHZ, a current from left to right is distributed on a stub (for example, a parasitic stub) of the first radiation part, and a current from right to left is correspondingly distributed on the second radiation part. Currents in the two radiation parts are reverse to each other. However, because the 2.9 GHz is already higher than the second frequency band (for example, around 2.8 GHz), the parasitic mode corresponding to the current 2.9 GHz is manifested out of the operating frequency band on S11. In this way, even if performance degradation occurs in the parasitic mode due to current reversal, normal operation of the antenna 141 is not actually affected.

In addition, as shown in FIG. 15, at a higher 2.95 GHZ, the second radiation part may further excite an obvious half-wavelength mode for operation.

With reference to the foregoing simulation description for the antenna solution 141, it can be learned that in an operating frequency band (for example, a frequency band covered by the CM mode and the DM mode), currents on the first radiation part and the second radiation part are both co-directional currents corresponding to each other. Therefore, in terms of the S-parameter, the antenna solution 141 may be manifested as having good radiation performance.

FIG. 16 shows an example of simulation comparison of the antenna solution 142 and the non-parasitic solution. Compared with the antenna solution 141, in the antenna solution 142, the second radiation part may include two second radiation units.

As shown in S11 in FIG. 16, in the antenna solution 142, two resonance depths are both improved to a certain extent, and a bandwidth is also optimized to a certain extent. From the perspective of radiation efficiency, in the antenna solution 142 in which the second radiation part is added, radiation efficiency in an entire frequency band is not lower than that in the non-parasitic solution. From the perspective of system efficiency, an efficiency peak value and an efficiency bandwidth of the antenna solution 142 are basically the same as those of the non-parasitic solution.

Therefore, during operation of the antenna solution 142, while the metal material is disposed on the secondary screen (for example, the second radiation part includes two second radiation units), the antenna solution 142 can provide radiation performance close to that in a case in which the metal material is not disposed (for example, the non-parasitic solution).

FIG. 16 further provides an example of current simulation corresponding to frequency points during operation of the antenna solution 142.

At 2.2 GHZ, two radiators of the first radiation part are directly distributed with co-directional currents, and the currents are in the CM mode. In addition, there is no significant current distribution on the second radiation part, and radiation of the first radiation part at this frequency point is not affected.

At 2.3 GHZ, two radiators of the first radiation part are directly distributed with co-directional currents, and the currents are in the CM mode. Currents in a direction the same as that of the first radiation part are also distributed in the two second radiation units on the second radiation part. Therefore, at 2.3 GHZ, disposition of the second radiation part does not have a negative impact on normal radiation of the first radiation part.

At 2.6 GHz, a current from right to left is distributed on a stub (for example, a parasitic stub) of the first radiation part. There is no significant current distribution on the second radiation part, and radiation of the first radiation part at this frequency point is not affected.

At 2.7 GHZ, two radiators of the first radiation part are directly distributed with reverse currents, and the currents are in the DM mode. There is no significant current distribution on the second radiation part, and radiation of the first radiation part at this frequency point is not affected.

At 2.7 GHZ, two radiators of the first radiation part are directly distributed with reverse currents, and the currents are in the DM mode. Currents in the DM mode in a direction the same as that of the first radiation part are also distributed in the two second radiation units on the second radiation part. Therefore, at 2.3 GHZ, disposition of the second radiation part does not have a negative impact on normal radiation of the first radiation part.

With reference to the foregoing simulation description for the antenna solution 142, it can be learned that, similar to the antenna solution 141 shown in FIG. 15, during operation of the antenna solution 142, in an operating frequency band (for example, a frequency band covered by the CM mode and the DM mode), currents on the first radiation part and the second radiation part are both co-directional currents corresponding to each other. Therefore, in terms of the S-parameter, the antenna solution 141 may be manifested as having good radiation performance.

With reference to the foregoing description of FIG. 14 to FIG. 16, when the second radiation part includes the second radiation units, a quantity of the second radiation units and a specific size difference of each second radiation unit (provided that a size of each second radiation unit is less than the half of the wavelength of the second frequency band) do not significantly affect actual operation of the antenna.

In some other embodiments, the second radiation part may further include more second radiation units.

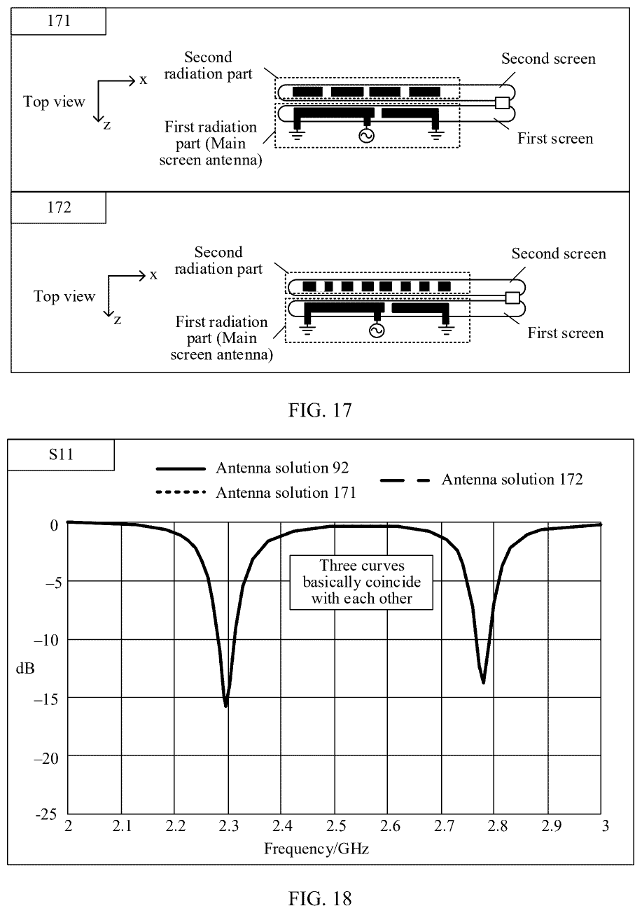

For example, refer to FIG. 17. In an antenna solution 171 provided in FIG. 17, the second radiation part may include four second radiation units separated by three gaps. A length of each second radiation unit is less than the half of the wavelength of the second frequency band.

In an antenna solution 172 provided in FIG. 17, the second radiation part may include eight second radiation units separated by seven gaps. A length of each second radiation unit is less than the half of the wavelength of the second frequency band.

FIG. 18 provides an example of S11 comparison of two antenna solutions shown in FIG. 17. S11 of the antenna solution 92 shown in FIG. 9 in the foregoing example is shown in FIG. 18 for comparison. It can be learned that when a quantity of second radiation units included in the second radiation partis 1, 4, or 7, S11 basically coincides, and radiation effects of the three antenna solutions are basically the same. That is, the quantity of second radiation units does not directly affect an overall radiation effect of the antenna.

In the foregoing example, a boundary of the second radiation unit or the first radiation unit in the second radiation part does not extend beyond the first radiation part. For example, in any one of the foregoing antenna solutions provided in this application, when the electronic device is in the closed state, a projection of the first radiation part onto the secondary screen is basically the same as a size of a region in which the second radiation part is located.

In some other embodiments of this application, the second radiation part may alternatively be set to be a projection region larger than the first radiation part.

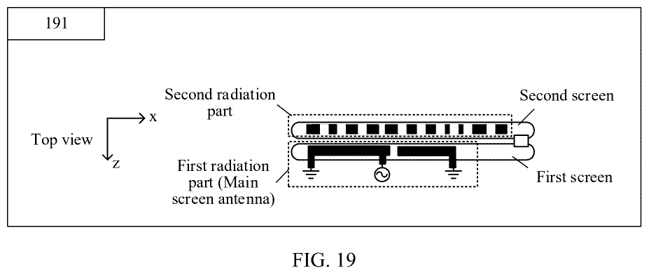

For example, referring to FIG. 19, in the antenna solution 191, the second radiation part may include a plurality of second radiation units, and the second radiation part extends beyond a projection region of the first radiation part.

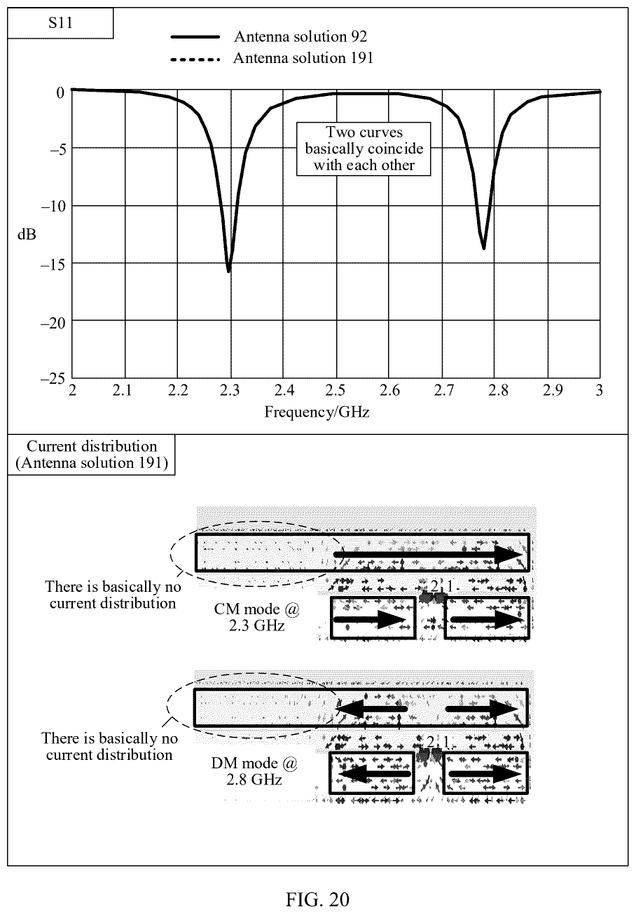

FIG. 20 is an example of an S-parameter and current simulation corresponding to the antenna solution 191.

As shown in S11 in FIG. 20, the antenna solution 191 basically coincides with S11 of the antenna solution 92. That is, an effect of disposing the second radiation part beyond the first radiation part is basically the same as an effect of disposing the second radiation part in correspondence to the first radiation part. As shown in the current simulation in FIG. 20, during operation of the antenna solution 191, the CM mode can be excited at 2.3 GHz for operation, and the DM mode can be excited at 2.8 GHz for operation. However, at the 2.3 GHZ and 2.8 GHZ, there is basically no significant current distribution on a stub that extends beyond the first radiation part and that is on the second radiation part. Therefore, even if the second radiation part is disposed beyond the projection region of the first radiation part, normal radiation of the first radiation part is not negatively affected.

It may be understood that, in FIG. 14 to FIG. 20, various variation solutions in a case in which the second radiation part includes the second radiation unit are described. Based on a similar principle, when the second part includes the first radiation unit, variation may also be correspondingly performed to obtain a similar radiation effect.

In some other embodiments of this application, the second radiation part may alternatively include one or more first radiation units and one or more second radiation units.

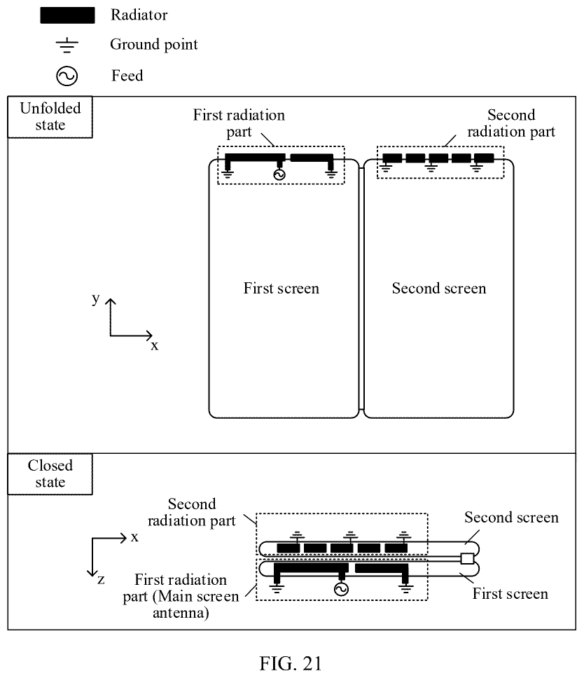

For example, refer to FIG. 21. An antenna solution provided in FIG. 21 may be referred to as an antenna solution 211.

In the antenna solution 211, the first radiation part is still disposed in a corresponding region of the first screen. The second radiation part is disposed in a corresponding region of the second screen. After the electronic device is closed, the second radiation part is included in a region of a projection of the first radiation part onto the second screen.

In the example in FIG. 21, the second radiation part may include three first radiation units and three second radiation units. The first radiation units and the second radiation units may be alternately disposed in sequence.

It may be understood that because a length of the first radiation unit is less than the quarter of the wavelength of the second frequency band, a length of the second radiation unit is less than the half of the wavelength of the second frequency band. Therefore, during operation of the antenna solution 211 shown in FIG. 21, disposition of the second radiation part does not have a negative impact on normal radiation of the first radiation part.

In some other embodiments of this application, dispositions of the first radiation unit and the second radiation unit in the second radiation part may be different from the example of the antenna solution 211.

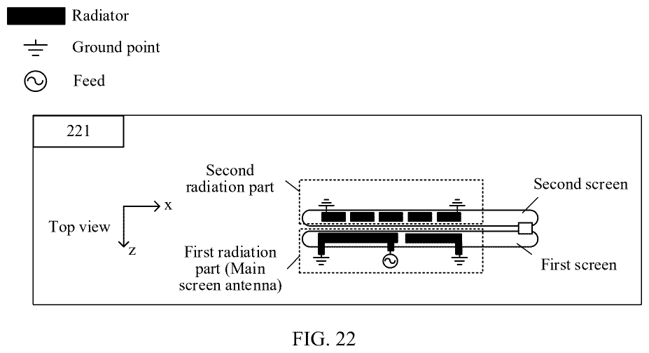

For example, referring to FIG. 22, an example of another antenna solution 221 is provided.

As shown in FIG. 22, the second radiation part in this example may include first radiation units disposed at two ends, and three second radiation units disposed between two first radiation units.

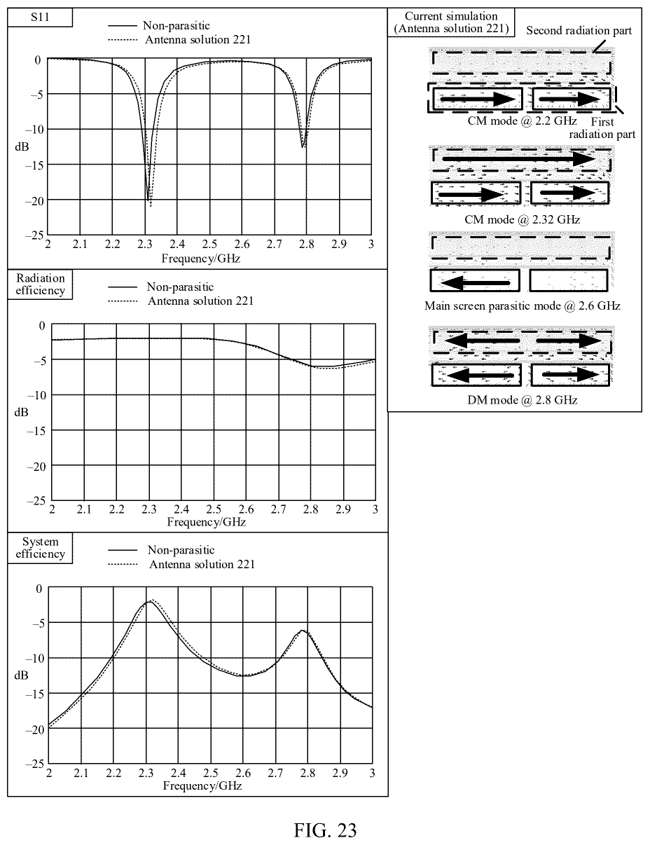

FIG. 23 provides an example of simulation of the antenna solution 221.

FIG. 23 shows an S-parameter simulation result. From the perspective of S11, the antenna solution 211 basically has no difference from S11 of the non-parasitic solution. From the perspective of radiation efficiency, there is basically no difference between radiation efficiency of the antenna solution 211 and radiation efficiency of the non-parasitic solution. From the perspective of system efficiency, there is basically no difference between system efficiency of the antenna solution 211 and system efficiency of the non-parasitic solution.

That is, in the antenna solution 221, when the second radiation part includes a plurality of first radiation units and second radiation units, a radiation effect similar to that in the non-parasitic solution can also be provided.

FIG. 23 further provides a current distribution status of each frequency point during operation of the antenna solution 221.

At 2.2 GHZ, the first radiation part operates in the CM mode, and there is no significant current distribution on the second radiation part.

At 2.32 GHz, the first radiation part operates in the CM mode, and a current in the same direction as that in the first radiation part is distributed on the second radiation part.

At 2.6 GHZ, a parasitic stub on the first radiation part radiates in a parasitic mode (or referred to as a main screen parasitic mode). There is no significant current distribution on the second radiation part.

At 2.8 GHz, the first radiation part operates in the DM mode, and a current in the same direction as that in the first radiation part is distributed on the second radiation part.

It can be learned that in an operating frequency band from 2.2 GHz to 2.8 GHZ, there is no significant current distribution on the second radiation part, or a current in the same direction with that on the first radiation part is distributed. Therefore, in the antenna solution 221, even if the second radiation part includes both the first radiation unit and the second radiation unit, a case in which normal operation of the first radiation part is affected due to that the second radiation part approaches the first radiation part can be avoided.

With reference to the foregoing description about various examples in which the second radiation part includes both the first radiation unit and the second radiation unit. In different implementations of embodiments of this application, a quantity of first radiation units, a quantity of second radiation units, and relative positions of the first radiation units and the second radiation units in the second radiation part are not limited.

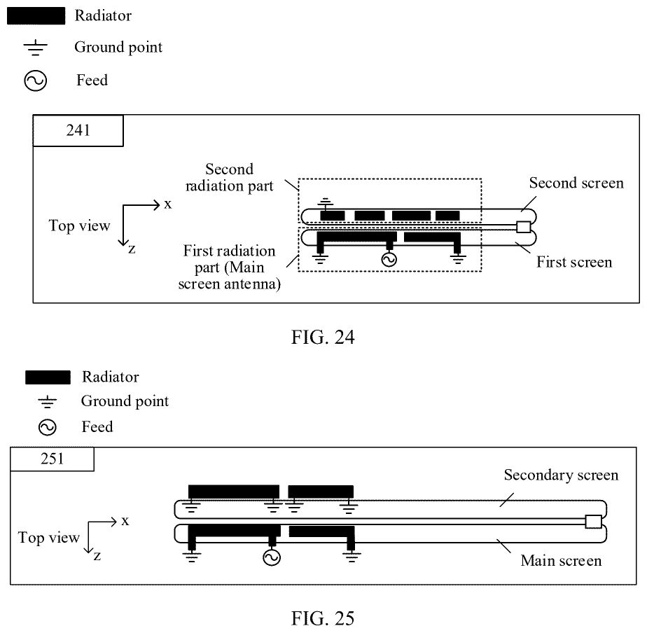

In an example, refer to FIG. 24. In an antenna solution 241 provided in FIG. 24, the second radiation part may include one first radiation unit and three second radiation units. The first radiation unit may be disposed in the second radiation part at a position corresponding to a projection of a ground point onto the first radiation part. The second radiation units are distributed in sequence on the same side of the first radiation unit. The second radiation part is included in a region of a projection of the first radiation part onto the second screen.

It may be understood that, in the antenna solution 241 provided in FIG. 24, a length of the first radiation unit is less than the quarter of the wavelength of the second frequency band, and a length of the second radiation unit is less than the half of the wavelength of the second frequency band. Therefore, a similar radiation effect provided by any one of the foregoing embodiments can be obtained. In a specific example, in the first radiation part, a length of a radiation stub to which a feed is coupled is configured to be 18.75 mm, and a length of a parasitic stub in the first radiation part is configured to be 18 mm. In the second radiation part, the length of the first radiation unit is configured to be 3 mm, and lengths of the three second radiation units are respectively configured to be 8 mm, 11 mm, and 7 mm. Based on the specific size configuration, it can correspond to that the length of the first radiation unit is less than the quarter of the wavelength of the second frequency band, and the length of the second radiation unit is less than the half of the wavelength of the second frequency band. Therefore, a radiation effect similar to that in the non-parasitic solution can be obtained.

The foregoing FIG. 8 to FIG. 24 describe an operating status of the antenna with various compositions of the second radiation part in embodiments of this application. It may be understood that this solution is not limited to that the first radiation part has a composition of the ANT 1 shown in FIG. 3. In other implementations, the first radiation part may further have any other antenna structure. Correspondingly, the second frequency band in the foregoing example may be a frequency band having a highest center frequency in one or more operating frequency bands when the first part radiates. In this way, regardless of an antenna form configured for the first radiation part, when the metal material (for example, the second radiation part) is configured for a corresponding region (that is, the secondary screen region) of the second screen, the parasitic resonance of the second radiation part is controlled to be higher than the second frequency, thereby obtaining radiation performance close to that of the non-parasitic solution. That is, a radiation impact of the metal material disposed in the secondary screen region on the main screen antenna is reduced to the greatest extent.

As a comparison, FIG. 25 provides another solution implementation of disposing a metal stub on the secondary screen. The antenna solution provided in FIG. 25 may be referred to as an antenna solution 251.

As shown in FIG. 25, different from the technical solution in this application in which the second radiation part is disposed on the second screen (that is, the secondary screen), in the antenna solution 251, two metal stubs whose two ends are grounded are disposed in a region corresponding to the main screen antenna (that is, a region of a projection of the main screen antenna onto the secondary screen when the electronic device is in the closed state).

A technical implementation of grounding the metal stub near the antenna is usually performed on a metal material in space near the antenna. In this way, energy radiated by the antenna that is coupled to the metal stub has a negative impact on normal operation of the antenna.

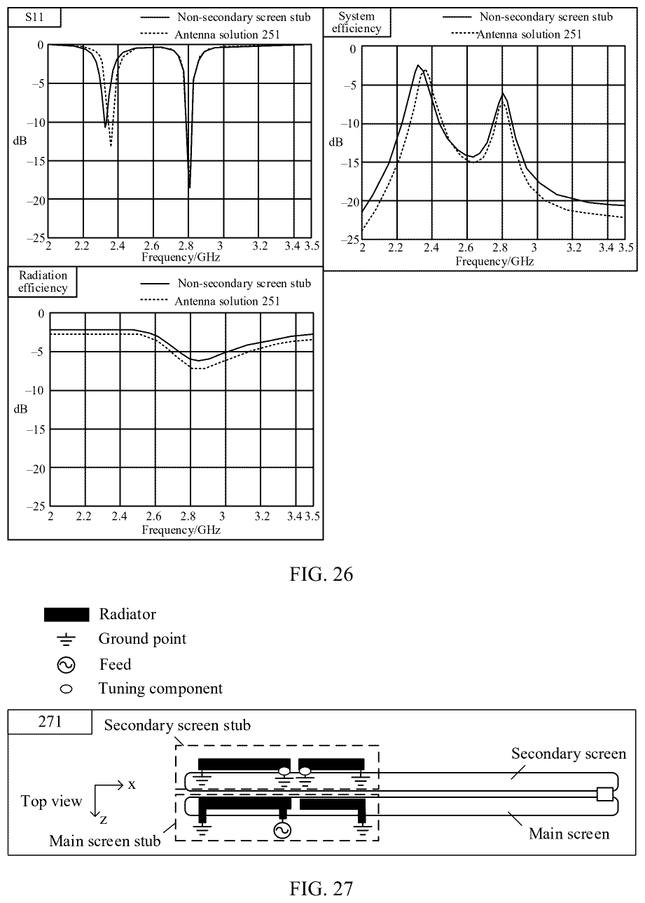

FIG. 26 provides an example of simulation of the solution shown in FIG. 25.

As shown in FIG. 26, from the perspective of S11, compared with a non-secondary screen stub solution (that is, the foregoing non-parasitic solution) in the antenna solution 251, the low frequency resonance is shifted toward a high frequency. From the perspective of radiation efficiency, the antenna solution 251 has at least 1 dB deterioration compared with the non-secondary screen stub solution. From the perspective of system efficiency, the antenna solution 251 deteriorates in both an efficiency peak value and an efficiency bandwidth compared with the non-secondary screen stub solution. This can be explained as: In the closed state, because the metal stub of the grounded secondary screen is close to the radiator of the antenna, some radiation of the antenna is directly reflowed to the reference ground. Consequently, radiation performance is deteriorated.

In some implementations, based on the antenna solution 251, a tuning component, such as an inductor, a capacitor, and/or a resistor, may further be disposed at a ground position of the secondary screen stub, to move an invalid resonance generated by the secondary screen stub out of an operating frequency band.

For example, refer to an antenna solution 271 provided in FIG. 27. On two radiators in the secondary screen stub, tuning components are respectively disposed, before being grounded, on one ends that are close to each other. Therefore, radiation performance in the closed state of the electronic device is optimized through adjustment of the tuning component.

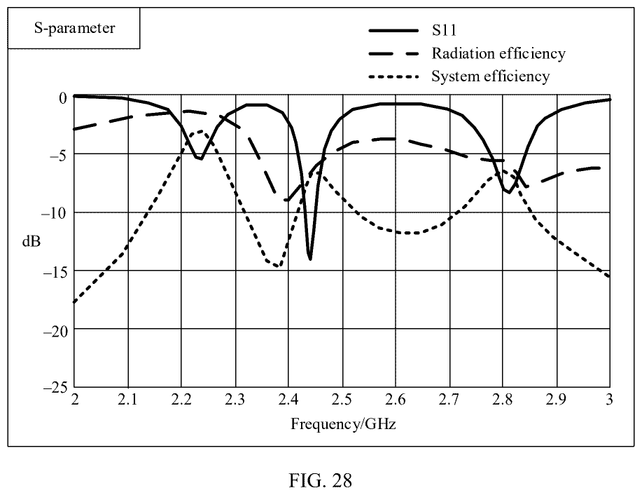

FIG. 28 provides an example of S-parameter simulation of the antenna shown in FIG. 27 during operation.

As shown in FIG. 28, through adjustment of the tuning component, 2.2 GHz to 2.3 GHZ and a frequency band around 2.8 GHz can be covered at S11. At S11, the parasitic resonance still occurs around 2.45 GHz. In view of radiation efficiency and system efficiency, there are significant efficiency pits between the parasitic resonance and the low frequency resonance, and between the parasitic resonance and the high frequency resonance.

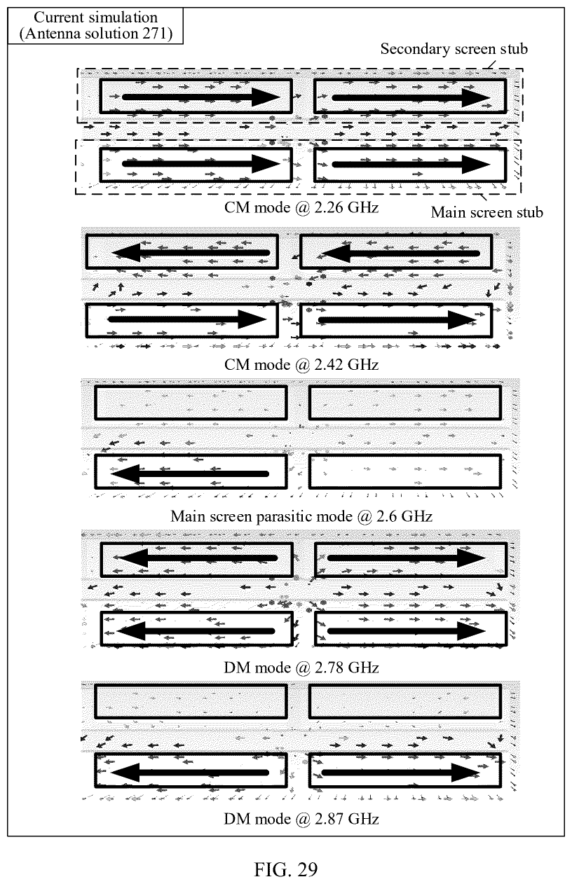

FIG. 29 provides an example of current simulation at various frequency points during operation of the antenna solution shown in FIG. 27.

At 2.26 GHz, radiation is performed on the secondary screen stub and a main screen stub in the CM mode. A current direction on the secondary screen stub is the same as a current direction on the main screen stub. In this case, the secondary screen stub does not significantly affect radiation of the main screen antenna.

At 2.42 GHz, radiation is performed on the secondary screen stub and the main screen stub in the CM mode. A current direction on the secondary screen stub is opposite to a current direction on the main screen stub. In this case, the secondary screen stub significantly affects radiation of the main screen antenna.

At 2.6 GHz, a current is mainly distributed on the parasitic stub of the main screen stub for radiation.

At 2.78 GHz, radiation is performed on the secondary screen stub and the main screen stub in the DM mode. A current direction on the secondary screen stub is the same as a current direction on the main screen stub. In this case, the secondary screen stub does not significantly affect radiation of the main screen antenna.

At 2.87 GHz, a current is mainly distributed on the main screen stub for radiation in the DM mode.

It can be learned that in a frequency band covered through the CM mode, a reverse current opposite to the current on the main screen stub is generated on the secondary screen stub, resulting in deterioration of performance in a low frequency part of the operating frequency band.

To describe beneficial effects that can be obtained by the antenna solutions provided in embodiments of this application more clearly, the following compares implementation effects of various antenna solutions provided in the foregoing embodiments. It is clear from this that, through the antenna solutions provided in embodiments of this application, radiation performance similar to that of the non-parasitic solution can be obtained when the metal material (for example, the second radiation part) is disposed in a corresponding region of the secondary screen (the second screen).

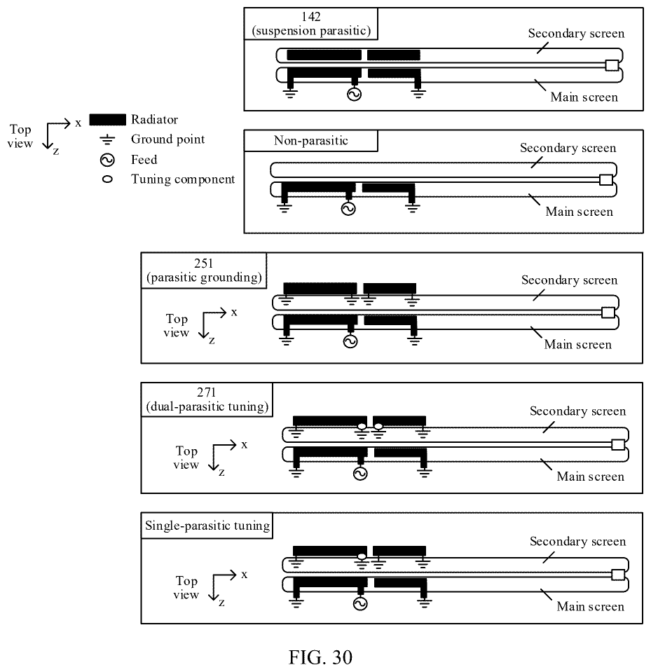

Referring to FIG. 30, several different antenna solutions are implemented when the metal material (for example, the metal frame) is disposed in a region corresponding to the main screen antenna on the secondary screen.

In this example, a suspension parasitic solution provided in embodiments of this application is provided in the antenna solution 142. That is, the second radiation part may include two second radiation units.

In the non-parasitic solution, the radiator of the antenna is disposed only on the main screen, and a corresponding region on the secondary screen is a clearance region. In this way, best radiation performance can be obtained. Performance of another antenna solution needs to approach the non-parasitic solution to the greatest extent.

The antenna solution 251 is a parasitic grounding solution. Referring to the description in FIG. 25, the secondary screen stub in this solution may include two grounded stubs. Through grounding processing, impact of the secondary screen stub on the main screen antenna is avoided.

The antenna solution 271 is a dual-parasitic tuning solution. On the basis of the antenna solution 251, the tuning component is added, so that a parasitic resonance generated by the secondary screen stub is tuned to be between the first frequency band and the second frequency band. Impact of the parasitic resonance on normal radiation of the first frequency band and the second frequency band is avoided.

FIG. 30 further provides an example of a single-parasitic tuning solution. According to the solution, on the basis of the antenna solution 271, one tuning component is removed, thereby reducing implementation costs of the antenna solution.

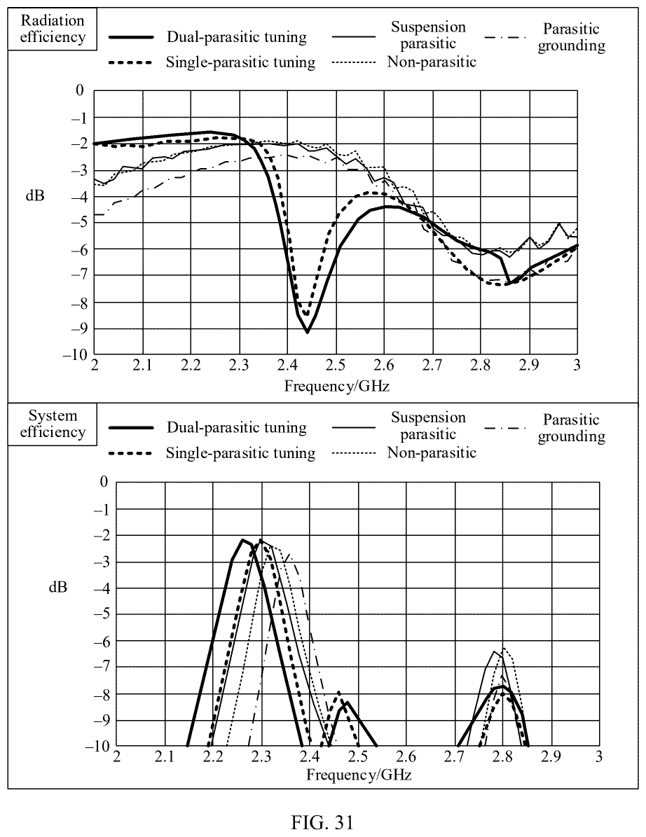

FIG. 31 provides simulation comparison of efficiency of the antenna solutions shown in FIG. 30.

As shown in FIG. 31, in terms of radiation efficiency, in the single-parasitic tuning solution and the dual-parasitic tuning solution, although the parasitic resonance is tuned to be between the first frequency band and the second frequency band, radiation efficiency of the first frequency band is improved. However, compared with the non-parasitic solution, the radiation efficiency of the second frequency band is greatly deteriorated. In the first frequency band and the second frequency band, compared with the non-parasitic solution, the parasitic grounding solution is significantly deteriorated. However, in the suspension parasitic solution, which is one of solutions provided in embodiments of this application, an effect most similar to that in the non-parasitic solution in the first frequency band and the second frequency band may be obtained in terms of radiation efficiency.

In terms of system efficiency, similar to the radiation efficiency, the suspension parasitic solution is a solution implementation that is most similar to the non-parasitic solution in all parts of the operating frequency band in all solution implementations.

It may be understood that, with reference to the foregoing description about variations of various antenna solutions provided in embodiments of this application, various antenna solution implementations that conform to the foregoing disposition of the second radiation part and that are provided in embodiments of this application can all obtain a radiation effect similar to that of the suspension parasitic solution. Compared with another solution implementation (such as parasitic grounding), good radiation performance can be provided. In addition, no tuning component needs to be added, so that corresponding hardware overheads and layout area overheads on the PCB can be reduced.

It should be understood that although this application is described with reference to specific features and embodiments thereof, it is clear that various modifications and combinations may be made to this application without departing from the spirit and scope of this application. Correspondingly, this specification and the accompanying drawings are merely used as examples of this application defined by the appended claims, and are considered as having covered any and all modifications, variations, combinations, or equivalents within the scope of this application. It is clear that, a person skilled in the art can make various modifications and variations to this application without departing from the scope of this application. In this case, if the modifications and variations of this application fall within the scope of the claims of this application and equivalent technologies thereof, this application is also intended to include these modifications and variations.

What is claimed is:

1. A terminal antenna, disposed in an electronic device, wherein the electronic device comprises a first part and a second part, and the first part is connected to the second part through a folding axis; and
the terminal antenna comprises: a first radiation part and a second radiation part, wherein
the first radiation part is disposed on the first part; at least one feed point is disposed on the first radiation part, the first radiation part receives a feed signal through the at least one feed point to radiate, an operating frequency band of the first radiation part comprises a first frequency band and a second frequency band; and a center frequency of the second frequency band is higher than that of the first frequency band;
the second radiation part is disposed on the second part; and when the electronic device is in a closed state, a projection of the first radiation part onto the second part at least partially coincides with the second radiation part; and
the second radiation part comprises at least one of the following:
at least one first radiation unit and at least one second radiation unit, wherein
a ground point is disposed on the first radiation unit; a length of the first radiation unit is less than a quarter of a wavelength of the second frequency band;
the second radiation unit is a suspended radiator; and a length of the second radiation unit is less than a half of the wavelength of the second frequency band.

2. The terminal antenna according to claim 1, wherein the first radiation part comprises: a first radiator and a second radiator, wherein
one end of the first radiator is coupled to a feed, and the other end of the first radiator is coupled to a reference ground; and
one end of the second radiator close to the first radiator is disposed in a suspended manner, and one end of the second radiator away from the first radiator is coupled to the reference ground.

3. The terminal antenna according to claim 2, wherein
a length of the first radiator corresponds to a quarter of a wavelength of the first frequency band, and a length of the second radiator corresponds to the quarter of the wavelength of the second frequency band.

4. The terminal antenna according to claim 1, wherein the electronic device is in the closed state; and
during operation of the terminal antenna, a current direction on the second radiation part is the same as a current direction on the first radiation part.

5. The terminal antenna according to claim 4, wherein that a current direction on the second radiation part is the same as a current direction on the first radiation part comprises:
a common mode CM mode is excited on the first radiation part to cover the first frequency band, wherein a current direction corresponding to the CM mode is a first direction; and
the current direction on the second radiation part is the first direction.

6. The terminal antenna according to claim 4, wherein that a current direction on the second radiation part is the same as a current direction on the first radiation part comprises:
a differential mode DM mode is excited on the first radiation part to cover the second frequency band, wherein
a current direction corresponding to the DM mode is from two ends to the middle; and the current direction on the second radiation part is from two ends to the middle; or
a current direction corresponding to the DM mode is from the middle to two ends; and the current direction on the second radiation part is from the middle to two ends.

7. The terminal antenna according to claim 1, wherein the electronic device is in the closed state;
the second radiation part comprises at least one first radiation unit; and
the first radiation unit excites a quarter-wavelength mode to radiate during operation of the electronic device, wherein a frequency band corresponding to the radiation of the first radiation unit is higher than the second frequency band.

8. The terminal antenna according to claim 1, wherein the electronic device is in the closed state;
the second radiation part comprises at least one second radiation unit; and
the second radiation unit excites a half-wavelength mode to radiate during operation of the electronic device, wherein a frequency band corresponding to radiation of the second radiation unit is higher than the second frequency band.

9. The terminal antenna according to claim 1, wherein
when the second radiation part comprises two or more radiation units, adjacent radiation units are separated through a gap.

10. The terminal antenna according to claim 1, wherein
the second radiation part comprises a plurality of the first radiation units and a plurality of the second radiation units, and the first radiation units and the second radiation units are alternately disposed.

11. The terminal antenna according to claim 1, wherein the second radiation part comprises two radiation units; and
on two radiation units in the second radiation part, tuning components are respectively disposed, before being grounded, on one ends that are close to each other.

12. An electronic device, wherein the electronic device comprises a terminal antenna, a first part and a second part, and the first part is connected to the second part through a folding axis; and
the terminal antenna comprises: a first radiation part and a second radiation part, wherein
the first radiation part is disposed on the first part; at least one feed point is disposed on the first radiation part, the first radiation part receives a feed signal through the at least one feed point to radiate, an operating frequency band of the first radiation part comprises a first frequency band and a second frequency band; and a center frequency of the second frequency band is higher than that of the first frequency band;
the second radiation part is disposed on the second part; and when the electronic device is in a closed state, a projection of the first radiation part onto the second part at least partially coincides with the second radiation part; and
the second radiation part comprises at least one of the following:
at least one first radiation unit and at least one second radiation unit, wherein
a ground point is disposed on the first radiation unit; a length of the first radiation unit is less than a quarter of a wavelength of the second frequency band;
the second radiation unit is a suspended radiator; and a length of the second radiation unit is less than a half of the wavelength of the second frequency band.

13. The electronic device according to claim 12, wherein
a signal is transmitted or received through a first radiation part in the terminal antenna when the electronic device is in a unfolded state; and a signal is transmitted or received through the first radiation part and a second radiation part in the terminal antenna when the electronic device in the closed state.

14. The electronic device according to claim 12, wherein
the first radiation part comprises: a first radiator and a second radiator, wherein
one end of the first radiator is coupled to a feed, and the other end of the first radiator is coupled to a reference ground; and
one end of the second radiator close to the first radiator is disposed in a suspended manner, and one end of the second radiator away from the first radiator is coupled to the reference ground.

15. The electronic device according to claim 14, wherein
a length of the first radiator corresponds to a quarter of a wavelength of the first frequency band, and a length of the second radiator corresponds to the quarter of the wavelength of the second frequency band.

16. The electronic device according to claim 12, wherein the electronic device is in the closed state; and
during operation of the terminal antenna, a current direction on the second radiation part is the same as a current direction on the first radiation part.

17. The electronic device according to claim 16, wherein that a current direction on the second radiation part is the same as a current direction on the first radiation part comprises:
a common mode CM mode is excited on the first radiation part to cover the first frequency band, wherein a current direction corresponding to the CM mode is a first direction; and
the current direction on the second radiation part is the first direction.

18. The electronic device according to claim 16, wherein that a current direction on the second radiation part is the same as a current direction on the first radiation part comprises:
a differential mode DM mode is excited on the first radiation part to cover the second frequency band, wherein
a current direction corresponding to the DM mode is from two ends to the middle; and the current direction on the second radiation part is from two ends to the middle; or
a current direction corresponding to the DM mode is from the middle to two ends; and the current direction on the second radiation part is from the middle to two ends.

19. The electronic device according to claim 1, wherein the electronic device is in the closed state;
the second radiation part comprises at least one first radiation unit; and
the first radiation unit excites a quarter-wavelength mode to radiate during operation of the electronic device, wherein a frequency band corresponding to the radiation of the first radiation unit is higher than the second frequency band.

20. The electronic device according to claim 1, wherein the electronic device is in the closed state;
the second radiation part comprises at least one second radiation unit; and
the second radiation unit excites a half-wavelength mode to radiate during operation of the electronic device, wherein a frequency band corresponding to radiation of the second radiation unit is higher than the second frequency band.
